(19) United States
(12) Patent Application Publication
(10) Pub. No.: US 2001/0053968 A1
(43) Pub. Date: Dec. 20, 2001

(54) System, method, and computer program product for responding to natural language queries

(75) Inventors: Boris Galitsky, Newton, MA (US); Maxim Grudin, Newton, MA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: IASKWEB, Inc.

(21) Appl. No.: 09/756,722

(22) Filed: Jan. 10, 2001

Related U.S. Application Data
(60) Provisional application No. 60/175,292, filed on Jan. 10, 2000.

(51) Int. Cl. G06F 17/27

(52) U.S. Cl. 704/9; 707/3; 707/4; 707/5

(57) ABSTRACT

A system, method, and computer-program product is provided for answering a natural language query in an automated manner. The answer is drawn from a body of textual information. Concepts in the body of textual information in a domain are expressed as a set of semantic headers. The semantic headers represent formalizations of select concepts in the information domain, and are created on the basis of expected queries. Moreover, queries are reduced to a canonical form. The answering process comprises the step of matching the formalized query, or translation formula, to one or more semantic headers. The pieces of text which correspond to those semantic headers are returned to the user as answers. The generality of a translation formula can be controlled. Steps can be taken to make the translation formula more general or less general. A user can clarify a translation formula if necessary. If the user provides a term that is not immediately recognized, then the user will be presented with a number of options. Each option represents one way in which the term in question can be clarified. The invention can then incorporate the new term into the translation formula and attempt to match one or more appropriate semantic headers. In addition, the domain can be expanded by parties other than the provider of the domain.

### CROSS-REFERENCE TO RELATED APPLICATIONS

This patent application claims priority to provisional patent application 60/175,292, “A Method and System for Natural Language Understanding,” filed at the UPS on Jan. 10, 2000, and incorporated herein by reference in its entirety.

### BACKGROUND OF THE INVENTION

1. Field of the Invention

The invention pertains to natural language processing, and more particularly to the processing of natural language queries in poorly formalized domains.

2. Related Art

The recent explosion of information available on the world wide web has shown question answering to be a compelling framework for finding relevant information, particularly in business domains. The success of question answering services in horizontal domains like ASKJEEVES, demonstrates the popularity of online question answering. Because both the questions and answers are expressed in natural language, question-answering methodologies deal with language ambiguities and incorporate both syntactic and semantic natural language processing techniques. Several current natural language processing-based technologies are able to provide the framework that approximates the complex problem of answering questions using large collections of texts.

Recently, information retrieval systems have been developed for question answering with respect to open domain text, providing new insights into techniques that are useful for question answering. In an information retrieval system, a set of documents is classified by the presence of certain keywords in the text. The documents on a specific topic are retrieved by looking for those that contain the keywords associated with that topic.

Other question answering systems rely on information extraction. In information extraction, only a fraction of the text is relevant. Information is represented by a predefined, fully formalized, relatively simple (in respect to the original text) structure, such as a set of logical expressions or a database. The extraction of the information of interest is the object of such systems, provided that the information is to be mapped into a predefined, target representation, known as a template. The templates are often imposed by interfaces to the databases.

The requirement that the information be mapped into a template can limit the utility of an information extraction system. In the income tax domain, for example, information is unstructured by its nature. In such unstructured domains database querying approaches are hardly appropriate. In the knowledge representation-via-database approach, meaning approximation leads to answers, where the answers are reductions of the original text. This is not as complete as ideally possible. If the query is misunderstood, the response will include extra objects and/or wrong objects.

The majority of approaches approximate question-answering with a combination of information retrieval and information extraction techniques. Current information extraction systems, however, make these combinations impractical for delivering answers for open-domain questions, due to the dependency of information-extraction systems on domain knowledge.

What is needed, therefore, is a system and method for providing answers to natural language queries, where the core natural language processing system is independent of the specific domain and does not represent knowledge as a database. Moreover, such a system should not require a user to extract the useful information from a list of documents.

### SUMMARY OF THE INVENTION

A system, method, and computer program product is provided for answering a natural language query in an automated manner. The answer is drawn from a body of textual information. The invention requires that some of the concepts in the body of textual information in a particular subject area (i.e., domain) as well as relationships between those concepts be expressed as a set of semantic headers. The semantic headers represent formalizations of select concepts in the information domain. The set of semantic headers is not exhaustive over the domain. Semantic headers are created on the basis of expected queries.

Moreover, queries are also formalized to a canonical form. The answering process comprises the step of matching the formalized query, or translation formula, to one or more semantic headers. The pieces of text which correspond to those semantic headers are returned to the user as answers.

The generality of a translation formula can be controlled. An attempt to match a translation formula to the set of semantic headers may produce no matching semantic headers. If this is the case, then the formalized query is deemed to be too narrow. Steps are then taken to make the query more general, so that at least one semantic header can be matched to the generalized query. An answer can then be provided to the user. On the other hand, the formalized query may match a large number of semantic headers, such that a large number of answers could be returned. Here the formalized query is deemed to be too general. If this is the case, steps are taken to narrow the query so that the number of matching semantic headers is reduced. The number of answers returned is thereby reduced.

The invention also has the feature of allowing a user to clarify a query. If the user provides a term in the query that is not immediately recognized by the invention, then the user will be presented with a number of options. Each option represents one way in which the term in question, or the question as a whole can be refined so that it is understandable to the system. The invention can then use the refined query to access the desired information.

The invention also allows expansion of the domain by parties other than the provider of the domain. For example, the invention can be provided to a client, to allow the client a mechanism through which its customers can ask questions. The invention permits the client to add additional information to the domain. The invention also allows the client to add to the set of semantic headers. To do this, the client can pose queries that had not originally been forseen. This permits the creation of additional semantic headers that can then be used to retrieve the appropriate answers when a customer poses such a query. Moreover, the invention provides for authorized customers of the client to likewise expand the domain.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the the digits that do not include the two right digits of a reference number identify the drawing in which the reference number first appears.

FIGS. 1A and 1B illustrate modules of the overall system, according to an embodiment of the invention.

FIG. 2 is a flow chart generally illustrating the overall method of an embodiment of the invention.

FIG. 3 is a flow chart illustrating the method of creating semantic headers, according to an embodiment of the invention.

FIG. 4 is a domain graph that illustrates the mapping of the domain structure.

FIGS. 5A and 5B collectively illustrate the operation of the an embodiment of the invention.

FIG. 6 is a flowchart illustrating the method of domain extension according to an embodiment of the invention.

FIG. 7 is a flowchart illustrating the method of providing an extendible domain to a client according to an embodiment of the invention.

FIG. 8 illustrates an example computing environment of the invention.

FIGS. 9A, 9B, and 9C collectively illustrate the system modules according to an alternative embodiment of the invention.

FIGS. 10A, 10B, and 10C collectively illustrate the process of an alternative embodiment of the invention.

### DETAILED DESCRIPTION OF THE PREFERRED EMBODIMENTS

A preferred embodiment of the present invention is now described with reference to the figures. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

Terminology

The following section defines some of the terminology used herein:

Domain knowledge: A body of information from which answers are extracted in response to a query. Also called a domain or problem domain. A domain composed of textual information that is relatively unstructured and not formalized is known in the art as a poorly formalized domain.

Predicate: A word or representation thereof that expresses a relationship between one or more arguments or properties of an argument. In the sentence “Mike owns the car,” the predicate is “owns.” A canonical representation of the sentence would be “owns(Mike, car).”

Metapredicate: A predicate whose argument(s) range over arbitrary well-formed formulas. An argument for a metapredicate is a metavariable. For the sake of simplicity, the term “predicate” will often refer both to first-order predicates and metapredicates.

Object: A word or representation thereof that serves as an argument for a predicate. Given that the sentence “Mike owns the car” can be expressed as “owns(Mike, car)” the objects are “Mike” and “car.”

Instantiation: The process of replacing an abstract or variable term with a specific object or predicate.

Instantiation state: Given an n-ary predicate, its instantiation state is the result of applying a binary function that maps each argument to the set {instantiated, uninstantiated}. Hence the predicate will be in one of 2ⁿ instantiation states.

Semantic header: A formal expression that represents one or more questions and is associated with part of the domain knowledge, which serves as an answer to those questions. Semantic headers represent relationships between the main concepts of the question. A semantic header can include predicates and/or metapredicates.

Semantic rule: A rule that transforms a translation formula into an expression that is called against the representation of the domain knowledge.

Semantic type: A classification of an object, analogous to the data type of a variable in a conventional programming language.

Translation: A process through which a natural language input query is converted into a formal representation.

Translation formula: A representation of an input query, using a formal language.

Overview

The invention provides a system, method, and computer-program product for providing an answer to a natural language query. The answer is drawn from a body of textual information. The retrieval process is both accurate and efficient, relative to other systems. The invention requires that some of the concepts in the body of textual information in a particular subject area (i.e., domain) be expressed as a set of semantic headers. The semantic headers represent formalizations of select concepts in the information domain. The set of semantic headers is not exhaustive over the domain. Semantic headers are created on the basis of expected queries.

Moreover, queries are also formalized. Queries are reduced to a canonical form. The answering process comprises the step of matching the formalized query to one or more semantic headers. The pieces of text which correspond to those semantic headers are returned to the user as answers.

The invention also provides for generality control. An attempt to match a formalized query to the set of semantic headers may produce no matching semantic headers. If this is the case, then the formalized query is deemed to be too narrow. Steps are then taken to make the query more general, so that at least one semantic header can be matched to the generalized query. An answer can then be provided to the user. On the other hand, the formalized query may match a large number of semantic headers, such that a large number of answers could be returned. Here the formalized query is deemed to be too general. If this is the case, steps are taken to narrow the query so that the number of matching semantic headers is reduced. The number of answers returned is thereby reduced.

The invention also has the feature of allowing a user to clarify a query. If the user provides a term in the query that is not immediately recognized by the invention, then the user will be presented with a response that contains a number of options to refine the input query. Each option represents one way in which the question can be refined. Each option can represent an alternative term to the one used in the original question or a complete question that is a more refined version of the input. By selecting one of the options, the user defaults to a question that is refined enough to be answered in a correct manner.

The invention also allows expansion of the domain by parties other than the provider of the domain. For example, the expansion mechanism associated with the invention can be provided to a client so that the client can add additional information to the knowledge domain. The invention also allows the client to add to the set of semantic headers. To do this, the client can introduce queries that had not originally been foreseen. This permits the creation of additional semantic headers, which can then be used to retrieve the appropriate answers when a customer poses such a query. In addition, the invention also provides for authorized customers of the client to likewise expand the domain.

II. System

The following section describes an embodiment of the system of the invention. The system can be viewed as a system of functional units. Each unit described below can be implemented in software or hardware, or a combination of the two. In an embodiment of the invention, the system is implemented in software using the PROLOG programming language, one version of which is provided by ARITY Corporation, of Concord, Mass.

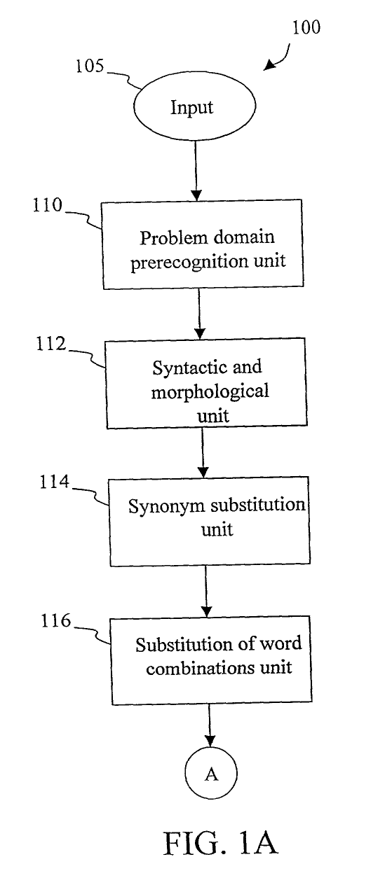

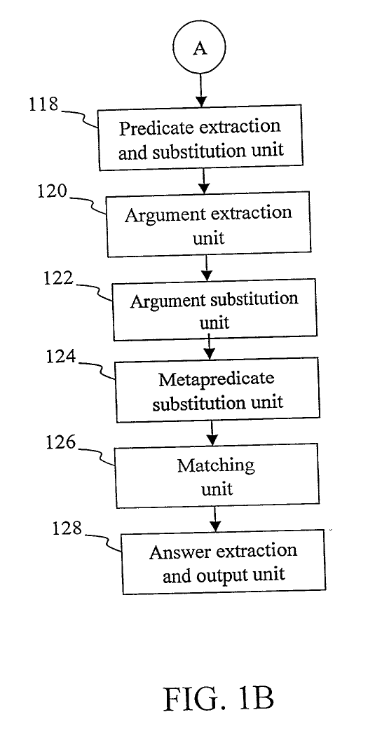

This embodiment of the invention is illustrated in FIGS. 1A and 1B. Input 105 represents a natural language input from a user. Such an input may, for example, be a natural language query.

In the preferred embodiment of the invention, the system of the invention is able to work with more than one knowledge domain. Problem domain prerecognition unit 110 is used if the domain is not predetermined. Unit 110 receives input 105 and analyses it in order to establish the domain to which the input query is referred. Each domain is assigned a specific set of relations or objects, traditionally called the trigger words. The specific set of trigger words for each domain is matched with the input. After the appropriate domain is identified, it is loaded into the system. If no domain is identified, a pre-defined domain is used by the system.

Syntactic and morphological unit 112 processes input query 105 in order to perform syntactic analysis of the input and transform all the words into their corresponding normal forms. Therefore, the past, present, and future tense versions of given verb, for example, are typically normalized to a single form by unit 112. If the form of a noun or verb is critical to the functioning of a domain, then each form for a noun or verb is assigned a meaning that is specific for the domain and is stored within the domain's representation. This is one of the properties of the invention that makes the semantic analysis independent of a particular domain representation.

Synonym substitution unit 114 maps establishes correspondence of the words in the input query to their pre-defined synonyms. This is useful because at later stages only one word out of a group of synonyms is used to represent any word in that group. The set of synonyms for a given word can vary from domain to domain. Hence in the preferred embodiment of the present invention the operation of substitution unit 114 is domain specific.

Substitution unit 114 sends its output to a unit 116 that performs substitution of word combinations. This unit performs substitutions of certain word combinations specified in the domain to their predefined representations, which for convenience are also called synonyms. As in the case with unit 114, the preferred embodiment of the unit 116 is domain specific.

Substitution of word combinations unit 116 sends its output to predicate extraction unit 118. Here, the input words are matched against the set of all predicates in the domain and the matches are identified and extracted.

Once the predicates in the input are extracted, argument extraction unit 120 generates a list of all arguments that are relevant to the extracted predicates. This list is then matched against the input to extract the object/subject references from the input query.

Argument substitution unit 122 assigns each of the extracted arguments to the predicates. This unit resolves any ambiguities. The substitution occurs in a translation template (uninstantiated translation formula) with no arguments having the same value.

Substitution of metapredicates unit 124 uses metapredicates to form the translation formula. This unit replaces the standard argument of a metapredicate, instantiated by a predicate symbol (the predicate name), with the complete expression, which consists of the predicate and its parameters. This unit operates according to the same semantic rules as Argument substitution unit 122. The difference between substitutions for predicates and metapredicates is that syntactic relations between words are more weakly correlated for the metapredicates than for the first-order predicates.

Matching unit 126 runs the resultant translation against the domain knowledge representation. Depending on the instantiation state, each term of the translation is matched against the corresponding fact or clause head in the logical program of the domain knowledge representation. This match either finds the values for the arguments or verifies the compatibility of values in the translation formula prior to matching. The ability to answer the “find an object” questions versus the “yes-no” ones is built-in for the PROLOG implementation of an embodiment of the invention.

Answer extraction and output unit 128 extracts answers associated with the semantic headers that were successfully matched to the translation formula and displays those answers on the output device.

Source code for a software implementation of this system is presented in the appendix to this application.

III. Method

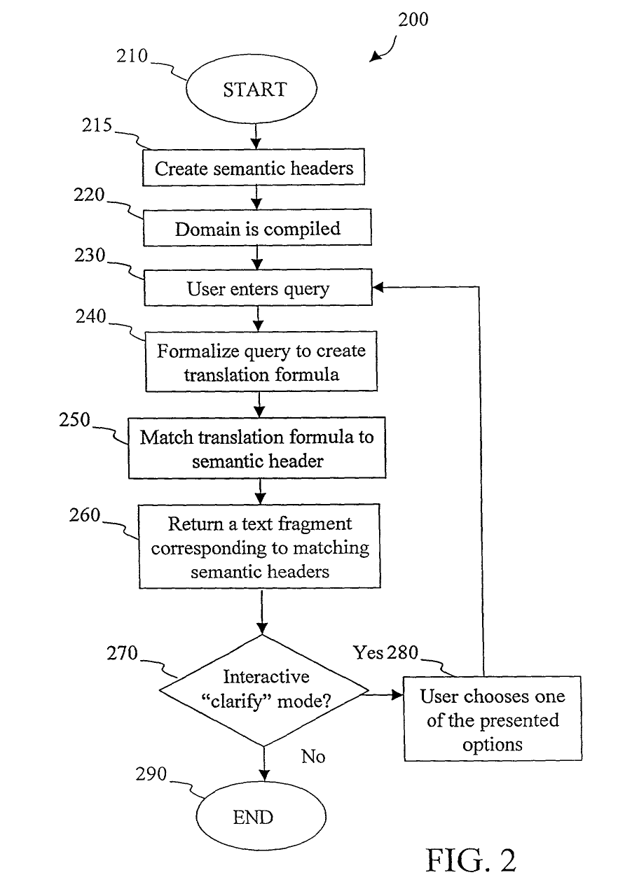

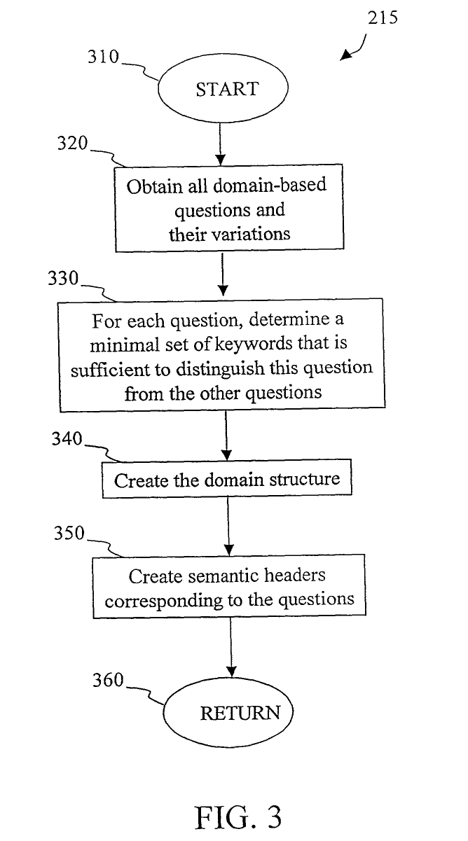

The overall method of the present invention is illustrated in FIG. 2. An embodiment of the method begins with step 210. In step 215, semantic headers are created for a body of textual information and associated with answers. A semantic header consists of one or more predicates, each of which has one or more arguments. Each argument can be an object or another predicate. A predicate serves to express a relationship between its associated arguments. The process of creating semantic headers will be illustrated in greater detail below with respect to FIG. 3. In step 220, the domain is compiled into an executable program.

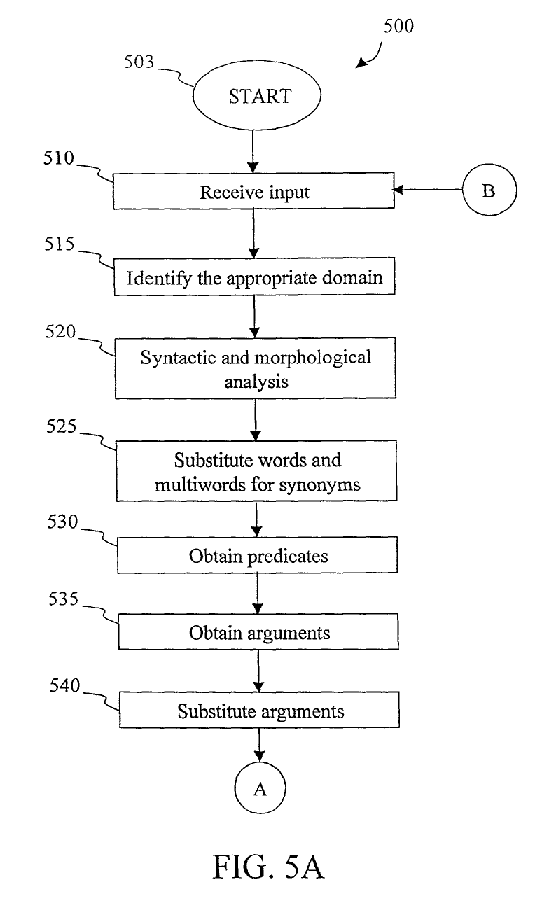

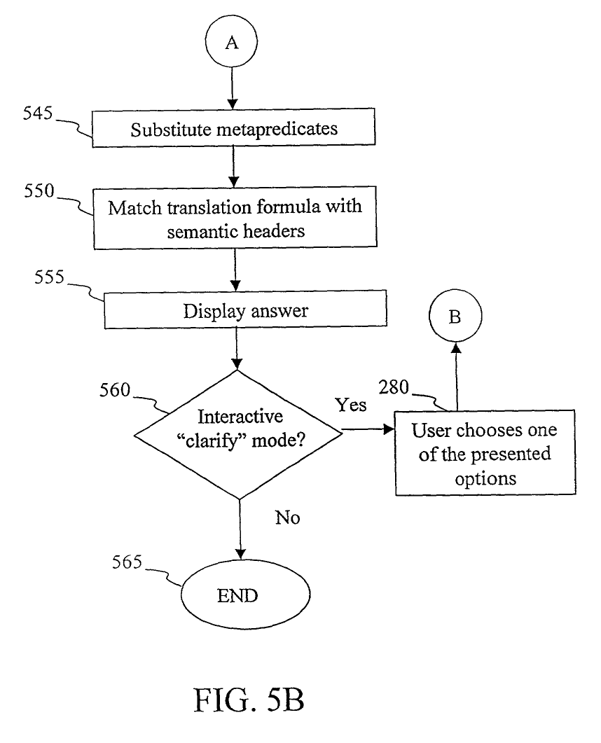

In step 230, a user of the system of the present invention enters a natural language query with respect to the domain of textual information. In step 240, the invention formalizes the user's query to create a translation formula. A translation formula is a canonical representation of the user's query. It can also be modified so as to convey the intent of the query in a manner that facilitates matching with the set of created semantic headers. Step 240 will be illustrated below with respect to FIGS. 5A and 5B.

In step 250, the translation formula is matched against the set of semantic headers. As a result, some semantic headers may be found to match the translation formula. In step 260, the system of the invention extracts the answers corresponding to the matched semantic headers. In an embodiment of the invention, the answers contain textual information in the hypertext mark-up language (HTML) format. Answers in alternative embodiments of the invention may contain other types of information, such as still and video images, sound, etc. The answers are provided to the user through an output device, which in the preferred implementation is a computer monitor.

In certain cases, when the user's question is ambiguous, the answer contains a series of options. Collectively, those options are referred to as the Clarify feature. In step 270, the system determines whether the answer requires clarification. In step 280, the user is presented with several options to refine the original formulation of the question. In the preferred embodiment of the invention, the clarification is performed in the following manner:

A certain predicate is obtained, which without an argument present can only correspond to an enumeration of questions each containing that predicate and an argument for that predicate. For example, in the tax domain, the translation formula deduct(X) with an uninstantiated argument X can most likely correspond to a questions such as: “What can I deduct?”. Alternatively, the user may ask a question that would contain an object not mapped in the system, for example: “Can I deduct my new Chevrolet?” The answer to translation formula deduct(X) should contain a list of items/expenses that can be deducted. The system of the invention identifies that the answer contains a list of specific questions and considers this case as a special Clarification case. An example of a clarification answer is “<clarify>Can I deduct <DDL>?</clarify><Iist>medical costs, travel, mortgage interest</list>”. The system will recognize tags <clarify> and </clarify> as denoting the interactive clarification mode, tag <DDL> as the place where the options should be inserted, and tags <list> and </list> as denoting the list of valid options.

Note that not every case of an uninstantiated argument needs to be considered for clarification—a semantic header deduction(X), with X being an uninstantiated argument, would most likely correspond to a question such as “What is a deduction?”

After choosing one of the options from the presented list, the user enters the refined question back into the system in step 230.

Once the user is presented with a definite answer in step 260, the process concludes at step 290.

Step 215, the creation of semantic headers, is illustrated in greater detail in FIG. 3. The process begins with step 310. In step 320, all questions that need to be answered by the domain are created and the answers to those questions are obtained. In step 330, all questions are processed in order to extract the most essential keywords. In an embodiment of the invention, the keyword extraction is done manually. The set of keywords should be large enough to allow it to distinguish each particular question from all other questions that are related to different answers.

Step 340 is the creation of the domain structure. The domain structure is a classification graph showing the relationships between predicates and objects of the domain. Edges in such a graph reflect relationships between the keywords extracted at step 330. However, only those combinations of edges that connect concepts used in a single question will be used in semantic headers. In an embodiment of the invention, a classification graph of a given domain is created manually way. In an alternative embodiment of the present invention, automated creation of the graph is done though a use of an appropriate software program.

There are several constraints that are followed when formalizing the domain structure:

1. The top of the graph should contain the main concepts used in the domain. Examples of such concepts for a financial domain may include IRA, mutual fund, tax, stock, bond. Those concepts should be obtained from a glossary. However, some other concepts may be present in the top level of the graph, depending on the domain;

2. Each question should be represented as a path linking one or more edges in the graph;

3. Elements at the top of the graph are predicates;

4. Elements at the bottom of the graph are arguments, if they are linked to a node from an upper level;

5. Each domain question should contain at least one predicate;

6. Frequently used keywords that are present in questions that point to many different answers should be located at or near the bottom of the graph. Those keywords are mostly useful once the main topic in the question is recognized. For example, the keyword “buy” can refer to many types of financial products, and therefore should be used as an argument. In the domain graph a node representing “buy” would be located under the nodes representing the financial concepts.

7. There are no horizontal links in the graph.

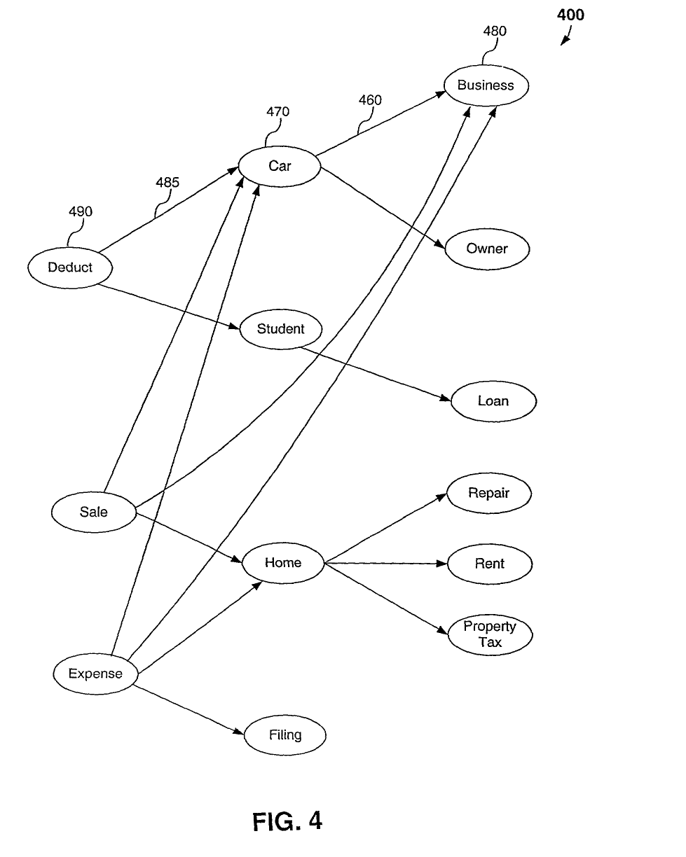

An example section of a domain structure is shown in FIG. 4. The top of the graph is located at the left of the FIG. 4. This example is from a domain concerning income taxation. The path 460 from node 470 (“car”) to node 480 (“business”) is a subgraph representing the notion of a car used for business reasons. This can be represented formally as car(1business). This subgraph can be combined with the path 485 from node 490 (“deduct”) to node 470. The result is a subgraph that represents the notion of deductibility of a car that is used for business reasons. This would be represented formally as deduct(car(business)). Both car(business) and deduct(car(business)) can be used as semantic headers that map to one or more fragments of text that discuss these ideas. Alternatively, if the answer does not adequately cover the relationships of those components, those semantic headers may be linked to other answers.

Returning to FIG. 3, in step 350, a semantic header corresponding to a particular question is created as a path that connects the key concepts used in that question. Given an edge between two nodes, the “top” node is considered a predicate, and the “bottom” node is considered an argument of that predicate. Therefore, if the path contains two edges linking three concepts, then the top node is considered a metapredicate.

Note that each semantic header is associated with a segment of text from the domain knowledge. Moreover, any segment of text may have more than one associated semantic header. Each semantic header corresponds to one or more queries that the associated text can answer.

An example implementation can be considered as the following part of an Internet Auction domain, which includes the description of bidding rules and various types of auctions. One paragraph from the domain may be as follows:

“Restricted-Free Access Auctions. This separate category makes it easy for you to find or avoid adults-only merchandise. To view and bid on adults-only items, buyers need to have a credit card on file with this auction srevice. Your card will not be charged. Sellers must also have credit card verification. Items listed in the adults-only category are not included in the New Items page or the Hot Items section, and currently, are not available by any title search.”

This paragraph introduces the “Restricted-Access” auction as a specific class of auctions, explains how to search for or avoid a selected category of products, presents the credit card rules and describes the relations between this class of auctions and other sections of the Internet auction site. Building a set of semantic headers for a given paragraph requires knowledge of the semantic model of the whole domain. Below is a list of questions that can be answered by the above paragraph:

1) What is the restricted-access auction? This question is raised when a customer knows the name of the specific class of auction and wants to get more details about it.

2) What kind of auction sells adults-only items? How do I avoid adults-only products for my son? How do you sell adult items? These are similar questions, but the class of auctions is specified implicitly, via the key attribute adults-only. The customers who pose these questions look for a response similar to that of the previous question.

3) When does a buyer need a credit card on file? Who needs to have a credit card on file? Why does a seller need credit card verification? These are more specific questions regarding what kind of auction requires having credit cards on file, and the difference in credit card processing for the seller and buyer. The paragraph above serves as an answer to these questions. Since we are not dividing the paragraph into smaller fragments, the customer will get more information than he/she has directly requested; however, this additional information is related to that request.

Below is the list of semantic headers for the answers above:

auction(restricted_access,_):-restrictedAuction.

product(adult,_):-restrictedAuction.

seller(credit_card(verification,_),_): -restrictedAuction.

credit_card(verification,_)):-restrictedAuction.

sell(credit_card(reject(_,_),_),_):-restrictedAuction.

bidder(credit_card(_,_),_),_):-restrictedAuction.

seller(credit_card(_,_),_),_):-restrictedAuction. what_is(auction(restricted_access,_):-restrictedAuction.

The process 215 concludes with step 360.

Steps 230 through 290 are collectively illustrated in greater detail, according to an embodiment of the invention, in FIGS. 5A and 5B, beginning at step 503. In step 510, an input (such as a natural language query) is received from a user.

If the specific domain to be used in answering the query is not yet identified, then the appropriate domain must be identified and loaded. This takes place in step 515. Each domain is assigned a specific set of relations or objects (traditionally called the trigger words). After an appropriate domain is revealed, it is loaded into the system, including semantic patterns for each predicate and all objects for each semantic type (alternatively, given sufficient memory, all domains may be pre-loaded for better performance). In an alternative embodiment of the invention, the specific domain is predetermined.

At step 520, the syntactic and morphological analysis is applied to the input query. In the preferred implementation, the words in the input query are transformed to their normal representation. No distinction is made between the different forms of a given word, unless such a distinction is required in a given domain. For example, in this step, singular and plural forms of a noun are resolved to a single form of the noun. Likewise different tenses of a given verb are all resolved to a single form of the verb. If the form of a word is critical to the functioning of a domain, then each form for the word is assigned a meaning that is specific for the domain. Each form would be stored within the domain's representation.

At step 525, words are substituted to their predefined synonyms whenever such substitution is possible. Furthermore, many commonly used word combinations are also substituted for predefined concepts. Note that both commonly used synonyms and domain-specific synonyms should be used depending on the domain.

In step 530, predicates are extracted. Here, the normalized words and substituted multi-words of the sentence are matched against the set of all predicates for the domain.

Argument extraction step 535 generates a list of all objects for all semantic types for the predicates extracted at step 530. This list is then matched against the input sentence to extract the arguments.

In argument substitution step 540, a transformation is made to make the translation formula less general and more specific. In this step, specific objects are substituted for uninstantiated arguments in the translations. This serves to reduce the number of semantic headers that will match the eventual translation formula.

Metapredicate substitution is performed in step 545. In this step, the abstract argument of a metapredicate, currently instantiated by a symbol of a predicate, is replaced by the whole term, i.e., the predicate with its arguments. For example, consider the input query “Who wants to own a car?” The following predicates are produced:

want(Smb, own), own(Smb, car),

where “Smb” can be interpreted as “somebody.” Metapredicate substitution yields:

want(Smb, own(Smb, car)).

In step 550, an attempt is made to match the resulting translation formula against the set of semantic headers. In step 555, the answers that correspond to the successfully matched semantic headers are displayed to the user on a computer screen. In an alternative embodiment, another output device may be used.

Step 560 is used to identify whether the answer contains an indication that the input question was ambiguous. If that is the case, then the clarification step 280 is performed. Upon completion of clarification step 280, the method returns to step 510. In step 510, the newly clarified input is received, and the process continues.

If, in step 560 it is determined that no clarification is needed, then the process ends at step 565.

Domain Extension

In the preferred embodiment of the invention, a user or other expert is able to extend the domain. If, for example, the invention is being used by a company to allow its customers to ask questions, some authorized customers may be given the ability to expand the domain. Moreover, the company providing the service may also be able to expand the domain. In neither case is the expertise of a knowledge engineer required. The domain extension process can operate by receiving either a query or an answer from an expert, or both query and answer. If only answers are received, then semantic headers for the new data are generated on the basis of expected queries. If only queries are received, then the existing domain is used to derive the semantic headers corresponding to the queries. If both are provided, then additional semantic headers are generated on the basis of the new queries along with any other expected queries. The answers are drawn from the newly expanded domain.

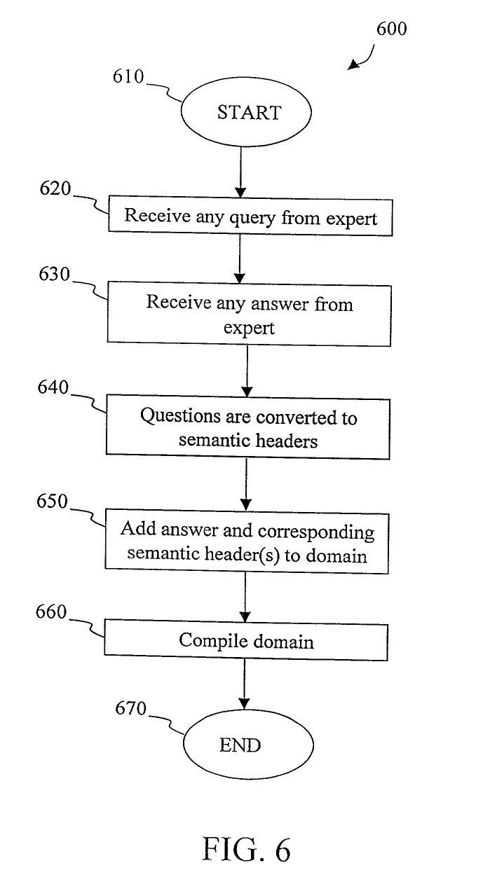

The process of domain extension begins with step 610 in FIG. 6. In step 620, the invention receives any queries that may be provided by an expert. In step 630, the invention receives any related answer that may be provided by an expert. In step 640, any queries received are processed to obtain translation formulas, which are then used as semantic headers. If no queries were received, queries are anticipated on the basis of any new answers received. Assuming that both a query and a related answer are received, then in step 650, the textual information representing any new answers is added to the domain. In addition, new semantic headers are generated on the basis of any newly received queries and/or any other expected queries. In step 660, the extended domain is compiled. The process concludes at step 670.

IV. Business Method

The ability of the invention to allow expansion of the domain permits a business method unlike the current methods of providing automated question answering tools to clients. A system can now be provided to a client, wherein the system can be expanded without requiring the work of knowledge engineers. Because the client can modify the query and answer tool as necessary or desirable, the tool is client-adaptable.

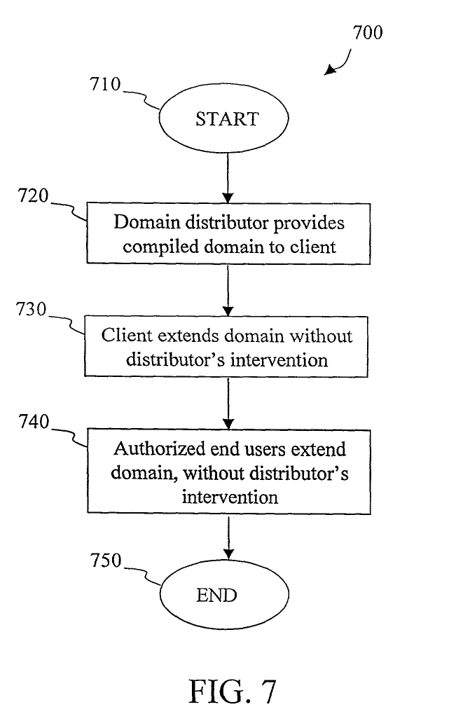

This process is illustrated in FIG. 7. The process starts with a step 710. In step 720, a distributor of a domain provides the compiled domain to a client. In step 730, the client can extend the domain, without the intervention of the distributor, by using the domain extension process described above. In step 740, an authorized end user of the domain can extend the domain, again, without intervention of the distributor. The process concludes at step 750.

V. Computing Environment

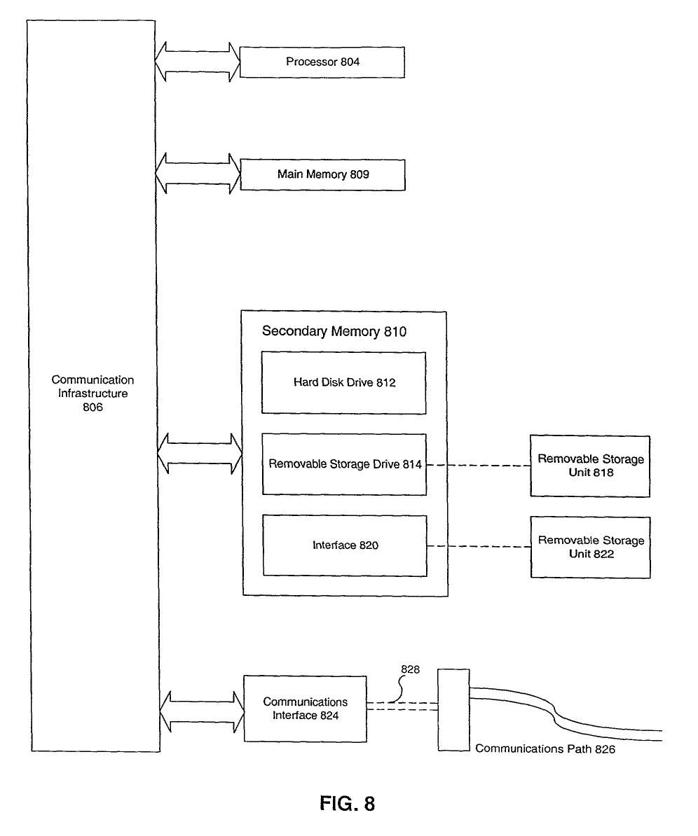

Components of the present invention may be implemented using hardware, software or a combination thereof and may be implemented in a computer system or other processing system. An example of such a computer system 800 is shown in FIG. 8 The computer system 800 includes one or more processors, such as processor 804. The processor 804 is connected to a communication infrastructure 806, such as a bus or network. Various software implementations are described in terms of this exemplary computer system. After reading this description, it will become apparent to a person skilled in the relevant art how to implement the invention using other computer systems and/or computer architectures.

Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well known manner. Removable storage unit 818, represents a floppy disk, magnetic tape, optical disk, or other storage medium which is read by and written to by removable storage drive 814. As will be appreciated, the removable storage unit 818 includes a computer usable storage medium having stored therein computer software and/or data. In an embodiment of the invention, secondary memory 810 contains the information representing the domain of interest.

In alternative implementations, secondary memory 810 may include other means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a PCMCIA slot and card, etc. Software and data transferred via communications interface 824 are in the form of signals 828 which may be electronic, electromagnetic, optical or other signals capable of being received by communications interface 824. These signals 828 are provided to communications interface 824 via a communications path (i.e., channel) 826. This channel 826 carries signals 828 and may be implemented using wire or cable, fiber optics, a phone line, a cellular phone link, an RF link and other communications channels. In an embodiment of the invention, signals 828 can include information constituting natural language input of a user, entered through a keyboard or other input device. Such input can be entered locally to computer system 800, or remotely via a network connection. Answers are likewise conveyed back to the user via channel 826.

In this document, the terms “computer program medium” and “computer usable medium” are used to generally refer to media such as removable storage units 818 and 822, a hard disk installed in hard disk drive 812, and signals 828. These computer program products are means for providing software to computer system 800.

Computer programs (also called computer control logic) are stored in main memory 808 and/or secondary memory 810. Computer programs may also be received via communications interface 824. Such computer programs, when executed, enable the computer system 800 to implement the present invention as discussed herein. In particular, the computer programs, when executed, enable the processor 804 to implement the present invention. Accordingly, such computer programs represent controllers of the computer system 800. Where the invention is implemented using software, the software may be stored in a computer program product and loaded into computer system 800 using removable storage drive 814, hard drive 812 or communications interface 824. In an embodiment of the present invention, logic (as illustrated in FIGS. 1A and 1B) for performing the method described above is implemented in software and can therefore be made available to a processor 804 through any of these means.

VI. Alternative Embodiment of the Present Invention

a. System of the Alternative Embodiment

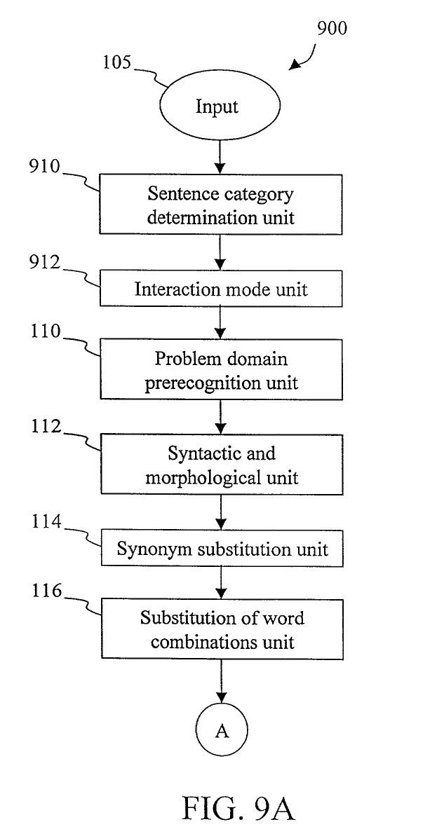

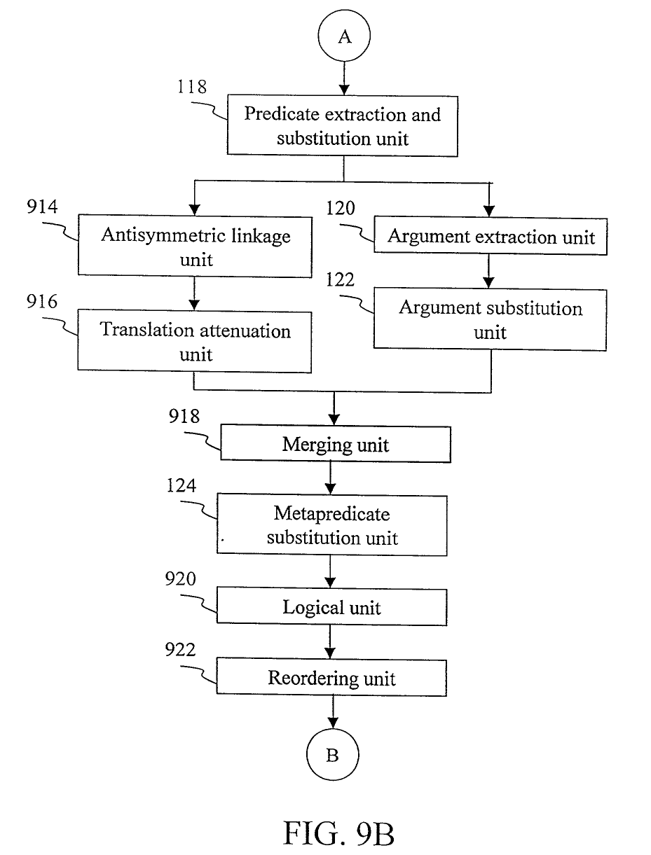

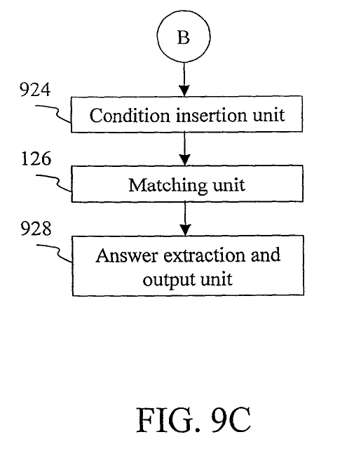

The following section describes an alternative embodiment of the system of the invention. This embodiment of the invention is illustrated in FIGS. 9A and 9B. This embodiment is an extended version of the preferred embodiment and therefore many units are shared. The units are the same as in FIG. 1, unless explicitly defined here.

Sentence category determination unit 910, Interaction mode unit 912 and Problem domain prerecognition unit 110 all receive Input 105. If input 105 is a statement, for example, Sentence category determination unit 910 classifies the statement as being a definition of an entity, definition of an object, or acquisition of a new fact. Such a determination is germane in the event that input 105 is being supplied by the user in an effort to expand the domain, for example.

Interaction mode unit 912 receives input 105. This unit facilitates processing subsequent queries that may arise in certain interaction modes. Subsequent queries may have to refer to objects and concepts of the current query. Interaction mode unit 912 supports such references by maintaining a representation of the previous queries and the answers that were provided in response to those queries.

Syntactic and morphological unit 913 is an extended version of the similar unit 112 used in the preferred embodiment of the invention. Additional features may include creation of a semantic tree, and other types of syntactic and morphological processing known in the art.

Antisymmetric linkage unit 914 receives input from Predicate extraction and substitution unit 118. The processing in unit 914 can take place in parallel with in units 120 and 122. Unit 914 serves to link or identify objects that occur in both an antisymmetric predicate and a symmetric predicate. In an antisymmetric predicate, the ordering of the arguments is significant in determining the meaning of the expression. For example from English, the sentence “The United States exports oil to Iran” has a very different meaning relative to the sentence “Iran exports oil to the United States.” Here, the predicate “exports” is antisymmetric and its arguments are “the United States” and “Iran.” An example of a symmetric predicate would be the statement “The United States is near Canada.” Here, the predicate is “near,” and the objects are “the United States” and “Canada.” In this latter example, the order of the arguments can be reversed and the meaning of the statement would be unchanged.

In some queries, arguments of an antisymmetric predicate may need to be identified with objects of a symmetric predicate. For example, given the query “What country exports oil to the country near Iran,” one of the objects of the antisymmetric predicate “export” needs to be identified with one of the objects of the symmetric predicate “near.” Antisymmetric linkage unit 914 performs this identification.

Translation attenuation unit 916 applies one or more transformations to a translation formula in order to increase its generality in the event that the translation formula fails to match any semantic header. If, for example, there is no semantic header that matches an expression p(a) in a translation formula, translation attenuation unit 916 may look for another predicate q and form q(p(a)), an expression that may match an available semantic header. If this also fails to match any semantic header, then the translation attenuation unit 916 may uninstantiate the argument a. This means that the argument of p is no longer specified, and can be matched with any argument of the correct semantic type. This is represented as the formula q(p(_)). Again, a matching semantic header will be sought. Another possible transformation would be to convert the expression q(p(a)) to the expression (p(a) & q(a)). Using transformations such as these, the translation formula is made more general in an attempt to find at least one semantic header that matches. This unit also weakens the relationships between the predicates.

Merge unit 918 serves to combine the outputs of translation attenuation unit 916 and argument substitution unit 122. The result is a translation formula that may have undergone generality adjustment.

This result is sent to metapredicate substitution unit 124, which replaces abstract arguments of a metapredicate.

The result of processing in metapredicate substitution unit 124 is sent to logical unit 920. This unit analyzes the need for logical connectives and constraints in the translation formula. A predetermined semantic model contains the scope of all propositional connectives for predicates and for their arguments. If a connective is needed to link two predicates, a corresponding symbol is inserted between them in the resultant translation. If two objects of a predicate are logically linked, then the translation includes the duplicate of the predicate, as well as the original. Each predicate has the same arguments, except that one predicate will have one of the linked objects, and the other predicate will have the other linked object. The two predicates will be linked by the appropriate connective.

The translation resulting from logical unit 920 is then sent to reordering unit 922, which performs the task of reordering predicates of the translation formula to achieve the proper instantiation state. For example, consider a pair of predicates such that the first predicate yields a value, while the second predicate verifies a constraint on the value of the first predicate but does not yield a value. The first predicate should be followed by the second predicate in the translation. Otherwise, the constraint-verifying predicate would fail, since its value would be as yet uninstantiated.

Condition insertion unit 924 extracts any requirements for searching for an object that possesses a maximum or minimum numerical value, e.g., the baseball player with the highest batting average. This unit adds an expression necessary to implement the minimum or maximum condition into the translation formula.

The result of processing in condition insertion unit 924 is a translation formula, which is matched against the semantic headers in matching unit 126. The result of matching is then sent to answer extraction and output unit 928, which is a modified version of unit 128 used in the preferred embodiment of the invention. The version used in this alternative embodiment performs generality control of obtained answers. If the system yielded no answer or more than a few answers then the translation formula is considered inadequate and its attenuation is performed. After that an attempt is made to match the attenuated formula until a satisfiable answer is received or it is determined that the query cannot yield such an answer.

In alternative embodiments of the invention, not all the units shown in FIGS. 9A-9C need to be present. Units 910, 912, 920, and 924 can be applied independently of each other. On the other hand, units 914, 916, 918 and 922 complement each other, and they cannot be used without each other.

Source code for generating a translation formula is presented in the appendix to this application.

b. Method of the Alternative Embodiment

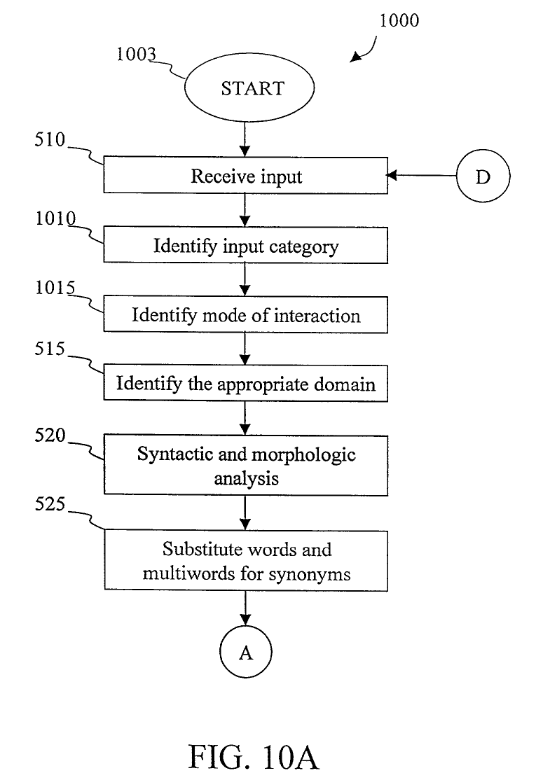

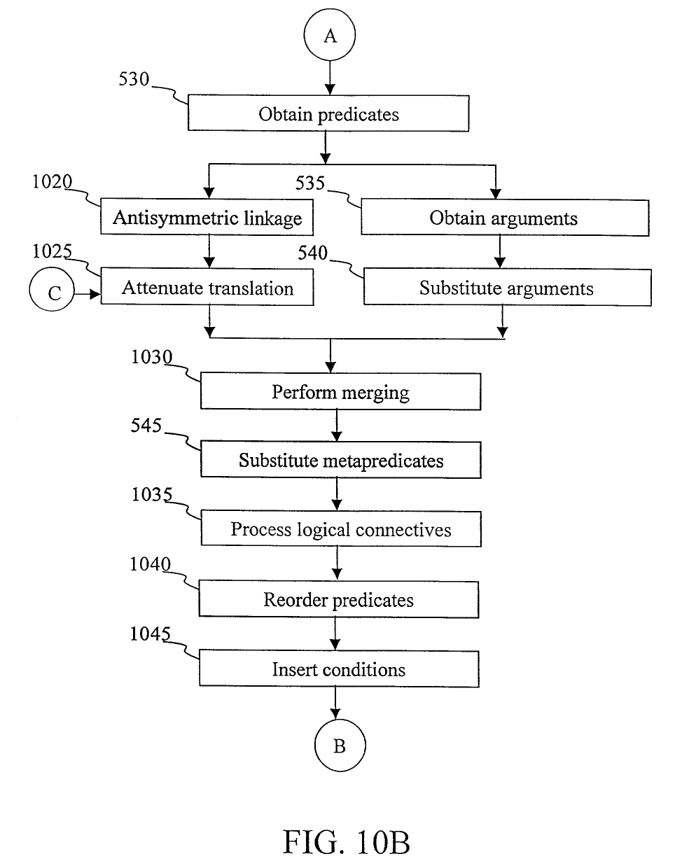

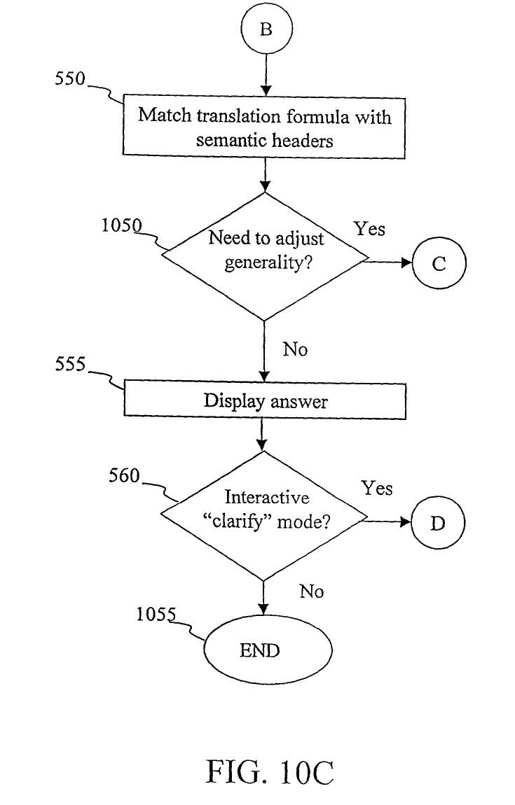

Steps of the alternative embodiment of the invention are collectively illustrated in FIGS. 10A, 10B, and 10C, beginning at step 1003. Many of the units are the same as in the preferred embodiment of the present invention, and they will only be described if their behavior is altered.

In step 1010, a determination is made as to whether the input is a statement or a query. If the input is a statement, then it is considered as a control statement, by which a user attempts to alter the mode of work of the system or extend the knowledge domain. If the statement comprises a command to extend the domain, then this step classifies the statement as being a definition of an entity, definition of an object, or acquisition of a new fact. Such a determination is germane in the event that the input is being supplied by the user in an effort to expand the domain, for example.

In step 1015 the mode of interaction identifies whether the query is a first question asked by the user on the particular topic of interest, or whether the query is a follow-up question. If it is a follow-up question, then step 1015 determines which terms the new query should borrow from the initial query or which information from the previous answer should be considered. That information is incorporated into the query.

Steps of antisymmetric linkage (1020) and translation attenuation (1025) can be executed in parallel with steps 535 and 540. In step of antisymmetric linkage 1020, the input arguments that occur in different predicates of the translation formula are identified. A translation formula, for example, may include both symmetric predicates and antisymmetric predicates. This step identifies arguments that are common across predicates.

For example, consider the natural language query “What country exports oil to the country near Iran?” Formalization gives rise to two predicates:

export (c1, c2, p)

near(c3, c4) Arguments c1 through c4 represent countries; p represents some product. near is a symmetric predicate, in that the order of the arguments can be changed without changing the meaning of the predicate. To say that c3 is near c4 is entirely equivalent to saying that c4 is near c3. export, on the other hand, is antisymmetric. The order of c1 and c2 is significant. To say that c1 exports to c2 is not equivalent to saying that c2 exports to c1. If c4 is Iran, either c1 or c2 must be identified with c3, which is a country near Iran. Step 1020 determines which argument, c1 or c2, is to be identified with c3.

In step 1025, attenuation of the translation formula is performed. In this step, adjustments are made to the translation formula so as to make the translation formula more general. This step serves to increase the number of semantic headers that match the translation formula. A number of transformations can be applied to a predicate to increase its generality. For example, given a predicate p(a) the generality of the predicate can be increased by making p(a) the argument of another predicate q. This results in a new predicate q(p(a)). If this new translation formula proves to be insufficiently general, other transformations can be applied. For example, the argument a can be uninstantiated. Another possible transformation would be to convert q(p(a)) to the expression p(a)&q(a). Other embodiments of the invention may feature other transformations to make a translation formula more general.

In the merge step 1030, the results of translation attenuation step 1025 and argument substitution step 540 are combined. The result is a translation that includes the appropriate antisymmetric linkages. The translation may have been attenuated or may have had some of its arguments instantiated by appropriate objects.

In step 1035, logical connectives (e.g., or) and constraints (e.g., only) are processed. A predetermined semantic model contains the scope of all propositional connectives for predicates and for their arguments. If a connective links two predicates, for example, a corresponding symbol is inserted between them in the resulting translation. If two objects are logically linked, then the translation will include the duplicate of the predicate where each copy of the predicate has the same arguments, except for these objects. For example, the concept of somebody wanting a car or truck becomes the equivalent disjunctive concept, i.e., somebody wanting a car or somebody wanting a truck. Hence,

wants(Smb, car or truck)

becomes

wants(Smb, car) or wants(Smb, truck).

To handle the concept of “only” an additional expression is added to the translation formula translation. All the values of the argument under the scope of “only” are found. It is then verified that this list contains the object specified in the translation formula.

In step 1040, predicates of a translation formula are reordered according to procedural semantics. This is done to achieve, for each predicate of the translation formula, an instantiation state wherein a matching semantic header can be found. If there is a pair of predicates with a common argument, which serves as an output from one of the predicates and as an input for the other predicate, then the former predicate must be followed by the latter predicate in the translation. This is necessary to assure that the formula will be matched if it can be potentially matched by a set of objects and/or formulas.

This is illustrated in the following formula

less(Temperature, 70), heat(acid, heatexchanger, Temperature) where the latter yields a value for Temperature and the former verifies the constraint that Temperature be less than 70. In the current order, predicate less would fail, since Temperature has not yet been evaluated. Hence the two predicates would be reversed in step 1040. This allows Temperature to be evaluated before testing it against the threshold constraint less.

In step 1045, the appropriate conditions are inserted in the translation. Here, the translation is scanned to identify any requirement that the answer contain the maximum or minimum of some numerical value. If such a requirement is found, then an expression is added to the translation to implement the condition. In an embodiment of the invention, the expression is of a procedural nature and is not explicitly mapped into by the input translation formula. For example, to implement the maximal condition, the following PROLOG expression can be added to the end of the translation in an embodiment of the invention:

[! Findall(Xnum,(MaxObjectFormula), Xs!], Xs\==[ ], quicksort(Xs,Sorts), last(Output, Sorts)

The step of generality control 1050 receives the result of matching the translation formula with the semantic headers, performed at step 550. This step determines whether the produced translation formula was precise enough not to be too ambiguous and yet not too detailed so that a positive match has been produced. This can be identified by checking the number of positive matches obtained from step 550. Ideally, step 550 should yield 1 match, with the preferred value being set at 2 matches. The acceptable number of matches may be dependent on a particular domain or implementation. If the number of of matches is found to be acceptable, then processing continues at step 555, where the obtained answers are displayed. Alternatively, attenuation of the translation formula is performed at step 1025. If after a certain number of attenuations (two in the preferred case) the system still fails to yield an acceptable answer, then the system exits.

The clarification step 560 is the same as in the preferred embodiment of the invention. The system ends its work at step 1055.

It should be understood that other embodiments of the present invention are possible. For example, The input can be received from a wide variety of input devices, including keyboards, speech recognition programs, handwriting recognition devices, etc. Similarly, the output devices can include printers, computer displays, etc. The parameters described in this descriptions can vary depending on the implementation and on the application of the system of the present invention.

VII. Conclusion

While various embodiments of the present invention have been described above, it should be understood that they have been presented by way of example, and not limitation. It will be apparent to persons skilled in the relevant art that various changes in detail can be made therein without departing from the spirit and scope of the invention. Thus the present invention should not be limited by any of the above-described exemplary embodiments, but should be defined only in accordance with the following claims and their equivalents.

What is claimed is:

1. A method of providing an answer, in a poorly formalized domain, to a natural language query, the method comprising the steps of:
(a) building a translation formula based on the query;
(b) matching the translation formula with a semantic header derived from the domain; and
(c) extracting the answer from the domain.

2. The method of claim 1, further comprising the step of:
(d) creating the semantic header for the answer, performed before step (b).

3. The method of claim 2, wherein said step (d) comprises the steps of:
(i) identifying expected queries with respect to the domain;
(ii) creating a graph of the domain structure;
(iii) determining subgraphs of the classification graph in accordance with the expected queries; and
(iv) creating a semantic header for each question.

4. The method of claim 1, further comprising the step of:
(d) clarifying the query, performed after step (b).

5. The method of claim 4 wherein said step (d) comprises the steps of:
(i) determining entities, from a predetermined set of entities, that could instantiate an uninstantiated expression in the translation formula;
(ii) presenting the determined entities to a user; and
(iii) receiving an indication from the user of a chosen entity.

6. The method of claim 1, further comprising the steps of:
(d) displaying the answer.

7. The method of claim 1, wherein step (a) comprises the steps of:
(i) performing concept extraction from the domain, based on the translation formula; and
(ii) controlling the generality of the translation formula.

8. The method of claim 7, wherein step (a) further comprises the step of:
(iii) normalizing a word of the translation formula, performed before step (i).

9. The method of claim 7, wherein step (a) further comprises the step of:
(iii) substituting a synonym for a word of the translation formula, performed before step (i).

10. The method of claim 7, wherein step (a) further comprises the step of:
(iii) substituting for a metapredicate in the translation formula, performed after step (i).

11. The method of claim 7, wherein said step (ii) comprises the steps of:
(A) testing for improper generality of the translation formula; and
(B) altering the generality of the translation formula.

12. The method of claim 11, wherein step (B) comprises the step of attenuating the translation formula.

13. The method of claim 12, wherein said step (B) further comprises the step of performing antisymmetric linkage, performed before said attenuating step.

14. The method of claim 11, wherein said step (B) comprises the step of argument substitution.

15. The method of claim 14, wherein said step (B) further comprises the step of argument extraction, performed before said argument substitution step.

16. The method of claim 1, wherein said step (a) comprises the step of processing logical connectives in the translation formula.

17. The method of claim 1, wherein said step (a) comprises the step of reordering the predicates of the translation formula according to procedural semantics.

18. The method of claim 1, wherein said step (a) comprises the step of performing condition insertion.

19. A method of extending a poorly formalized domain, comprising the steps of:
(a) receiving at least one of a query and an answer from an expert;
(b) if the query is received, translating the query into at least one semantic header;
(c) if the query and the answer are received, adding the answer and the corresponding at least one semantic headers to the domain, to form an extended domain; and
(d) compiling the extended domain.

20. A method of providing a query and answer tool adaptable by a client, comprising the steps of:
(a) providing a compiled domain to a client;
(b) enabling a extension of the domain without the assistance of a knowledge engineer.

21. The method of claim 20, wherein said step (b) comprises the step of enabling the client to extend the domain without the assistance of a knowledge engineer.

22. The method of claim 20, wherein said step (b) comprises the step of enabling an authorized user of the domain to extend the domain without the assistance of a knowledge engineer.

23. A computer program product comprising a computer usable medium having computer readable program code means embodied in said medium for causing an application program to execute on a computer that provides an answer, in a poorly formalized domain, to a natural language query, said computer readable program code means comprising:
(a) computer readable program code means for causing the computer to build a translation formula based on the query;
(b) computer readable program code means for causing the computer to match the translation formula with a semantic header derived from the domain; and
(c) computer readable program code means for causing the computer to extract the answer from the domain.

24. The computer program product of claim 23, further comprising:
(d) computer readable program code means for causing the computer to create the semantic header for the answer.

25. The computer program product of claim 23, further comprising:
(d) computer readable program code means for causing the computer to clarify the translation formula.

26. The computer program product of claim 23, further comprising:
(d) computer readable program code means for causing the computer to display the answer.

27. The computer program product of claim 23, wherein said computer readable program code means (a) comprises:
(i) computer readable program code means for causing the computer to perform concept extraction from the domain, based on the translation formula; and
(ii) computer readable program code means for causing the computer to control the generality of the translation formula.

28. A computer program product comprising a computer usable medium having computer readable program code means embodied in said medium for causing an application program to execute on a computer that extends a poorly formalized domain, said computer readable program code means comprising:
(a) computer readable program code means for causing the computer to receive at least one of an answer and a query from an expert;
(b) computer readable program code means for causing the computer to translate the answer into at least one semantic header, if an answer is received;
(c) computer readable program code means for causing the computer to add the answer and the corresponding at least one semantic header to the domain, if a query and answer are received, to form an extended domain; and
(d) computer readable program code means for causing the computer to compile the extended domain.
